(19) United States
(12) Patent Application Publication
(10) Pub. No.: US 2012/0248849 A1
(43) Pub. Date: Oct. 4, 2012

(54) WHEEL HUB DRIVE UNIT

(75) Inventors: Raphael Fischer, Herzogenaurach (DE); Michael Bogner, Eckental (DE)

(73) Assignee: SCHAEFFLER TECHNOLOGIES AG & CO. KG, Herzogenaurach (DE)

(21) Appl. No.: 13/513,687

(22) PCT Filed: Dec. 1, 2010
(86) PCT No.: PCT/EP2010/068657

§ 371 Date: Jun. 4, 2012

(30) Foreign Application Priority Data
Dec. 7, 2009 (DE) 10 2009 057 320.8

(51) Int. Cl. B60T 1/06

(52) U.S. Cl. 301/6.1

(57) ABSTRACT

A wheel hub drive unit for driving a motor vehicle wheel, with the unit including a wheel hub drive that has a bearing element (14) by which the wheel hub drive is arranged on a wheel hub (20) of the motor vehicle. The wheel hub drive has a mechanically designed blocking element (40) for applying a braking force to the wheel hub (20).

### BACKGROUND

The invention relates to a wheel hub drive unit for driving a vehicle wheel of a motor vehicle with a wheel hub drive.

A wheel hub drive is typically arranged directly on a vehicle wheel of a motor vehicle or integrated within the vehicle wheel. A wheel hub drive usually has a motor unit by which the wheel hub and thus the vehicle wheel of the motor vehicle can be driven. Such a wheel hub drive or such a wheel hub drive unit is advantageously used for electric vehicles. One problem in such wheel hub drive units, especially for use in electric vehicles, is the design of a climbing assist feature, by which an automated support for the motor vehicle is enabled when driving up inclines and the motor vehicle is prevented from rolling back down the incline. Such a climbing assist feature is typically realized by a braking system of the motor vehicle, wherein the driver does not have to actuate and/or release the braking system, in particular, an operating or emergency braking system of the motor vehicle. The braking system or brakes of the braking system are usually controlled here by software. This requires complicated algorithms, because the gas pedal position or the engine speed, the clutch path, the drive torque generated by the motor or transmitted via the clutch and additional parameters must be evaluated and converted into a useful braking behavior by the controller.

In the case of motor vehicles that have a wheel hub drive unit, the motor vehicle, as already discussed above, is typically driven purely by an electric motor, so that especially in such motor vehicles, a standstill phase of the motor vehicle at an incline can be problematic. Clutch sliding, as can happen in a motor vehicle operated by an internal combustion engine, is not possible here. Indeed, the motor unit of the wheel hub drive could also be powered in the standstill phase, but here the high power consumption and the strong heating of the engine are disadvantageous. If the standstill phase on an incline occurs in combination with extended stop-and-go traffic, this can considerably reduce the remaining electric range.

### SUMMARY

The objective of the invention is therefore to provide a wheel hub drive unit in which a more energy-efficient braking force effect can be achieved.

This objective is met according to the invention by the features of the invention. Advantageous designs are specified below and in the claims.

The wheel hub drive unit according to the invention for driving a vehicle wheel of a motor vehicle has a wheel hub drive that has a bearing element by which the wheel hub motor is arranged on a wheel hub of the motor vehicle. The invention distinguishes itself in that the wheel hub drive has a mechanical blocking element for applying a braking force on the wheel hub.

Through the use of the mechanical blocking element, it is possible to integrate an additional mechanical feature into the wheel hub drive, which can be used as a climbing assist feature or else also as a parking brake. Through use of the mechanical blocking element, it is possible to apply a braking force on the wheel hub, without increasing the power consumption of the motor unit of the wheel hub drive and without producing an increased or reinforced heating of the motor unit of the wheel hub drive. Thus it is possible to realize a standstill phase on an incline also in combination with extended stop-and-go traffic for the motor vehicle and for the wheel hub drive unit in the gentlest way possible. Because the blocking element is mechanical, a complicated design of the blocking element, such as, for example, providing the blocking element with a complicated controller, is not required. Thus, the provision of complicated algorithms that must be first evaluated by an evaluation unit, in order to then by forwarded to another typical controller to actually be able to trigger a braking effect, can be eliminated. The braking force is advantageously applied by the blocking element indirectly on the wheel hub.

According to one advantageous design of the invention, it is provided that for applying the braking force, the blocking element acts in the radial and/or axial direction relative to the rotational axis of the wheel hub on a surface of the bearing element. The blocking element can act directly, for example, on a lateral surface of a bearing outer ring of the bearing element and/or on an end face of the bearing outer ring, in order to exert a braking force indirectly on the wheel hub. This is then advantageously provided when the bearing outer ring has a rotating design. For example, the lateral surface of the bearing outer ring could be used as a kind of clamping surface for a blocking element. It is likewise possible that the end face of the bearing outer ring can be used as a functional surface for a blocking element, for example, in the form of an axial blocking element. If the lateral surface of the bearing outer ring has a conical design, then it is further possible to provide the blocking element in the form of a conical ring that can be pushed in the axial direction on the lateral surface, in order to apply a braking force on the bearing element. Furthermore, it would also be possible that the lateral surface of the bearing outer ring is provided with contours in which the blocking element can engage, for example, the blocking element is designed in the form of brake cams that can engage in the contours of the lateral surface and thus can generate a braking force. These brake cams can have either a symmetrical or also a non-symmetrical design, so that they allow a free-running effect, that is, a selective directional braking. If the blocking element is arranged in the region of the bearing element, then the wheel hub drive having the blocking element can have an especially compact design.

According to an alternative design of the invention, for applying the braking force, the blocking element could act in the radial and/or axial direction relative to the rotational axis of the wheel hub on a surface of a brake drum provided on the wheel hub drive. The blocking element can here act directly on an inner lateral surface, an outer lateral surface, and/or an end face of the brake drum, in order to apply a braking force indirectly on the wheel hub. If the blocking element is provided in the region of the brake drum, a larger effective diameter and thus a more effective braking effect can be achieved.

As an alternative hereto, it is also possible that for applying the braking force, the blocking element acts in the radial and/or axial direction relative to the rotational axis of the wheel hub on a surface of a flange journal provided on the wheel hub drive. This is then advantageously provided when the bearing inner ring of the bearing element has a rotating design, because here the flange journal is advantageously extended past the bearing outer ring of the bearing element and this extension can be used in the radial or axial direction to provide a blocking element that can apply a braking force on the wheel hub via the flange journal.

It is further preferably provided that the blocking element can be actuated by an electric motor, electromagnet, and/or mechanical system. If the blocking element has an electric motor design, an especially high efficiency can be achieved. If the blocking element can be actuated mechanically, then an especially simple design and easy handling are possible.

According to another advantageous design of the invention, the blocking element comprises a free wheel. A free wheel, also called a directionally switched clutch, has a shaft and an outer ring, wherein the shaft can also be designed as an inner ring. Catch elements are arranged between the shaft and the outer ring, with these catch elements allowing a rotation of the shaft relative to the outer ring in a direction, the so-called free-running direction, and blocking rotation of the shaft relative to the outer ring in the opposite direction, the so-called blocking direction.

If the free wheel is designed as a mechanical free wheel, then it is possible that the controller of the drive motor can form a pre-drive, without having to coordinate with the brake management.

The free wheel can further be designed as a switchable free wheel. In a switchable free wheel, the catch elements can be moved into a switched-off position in which they are not functional, that is, they cannot block rotation of the shaft relative to the outer ring in any direction. In the switched-off position, the shaft can rotate in two directions relative to the outer ring. In a switched-on position, a switchable free wheel has the typical function of a free wheel in the form of the ability of the shaft to rotate relative to the outer ring in one direction and the blocking of rotation in the opposite direction.

It is further possible that the free wheel is constructed as a wrap wall clutch, a wrap wall spring, or a wrap spring clutch. A wrap spring clutch typically consists of a spiral spring that is wound on a shaft or a cylindrical body and that is attached on the drive on one side. The entraining effect is based on the fact that the entraining torque increases and sums with each winding due to friction. Therefore, due to the wrapping, the force causing this friction can be simultaneously increased. In the opposite direction, a smaller friction occurs; the spring increases its diameter somewhat but does not unwind.

Furthermore it is possible that the free wheel is designed as a clamping body free wheel. The advantageous of using a clamping body free wheel is the low mass moments of inertia of the clamping bodies while simultaneously increasing the contact surface. Thus, for small reaction times, high torques can be absorbed.

Furthermore it is also possible that the free wheel is designed as an anti-hopping clutch, a claw clutch, or a conical clutch.

According to another advantageous design of the invention, it is further preferably provided that a first free wheel and a second free wheel are provided, wherein the first free wheel and the second free wheel can be activated separately from each other by a switchover catch. Therefore it is possible to provide a climbing assist feature for driving up inclines and also for driving down inclines.

The invention further relates to a motor vehicle, in particular, an electric vehicle, comprising a wheel hub drive unit designed and refined as described above.

### BRIEF DESCRIPTION OF THE DRAWINGS

The invention will be explained in more detail below using preferred embodiments with reference to the attached drawings.

Shown are:

FIG. 1 is a schematic representation of a wheel hub drive unit according to the invention with possible positions of a blocking element according to the invention,

FIG. 2 is a schematic representation of a first embodiment of the blocking element according to the invention,

FIG. 3 is a schematic representation of a second embodiment of the blocking element according to the invention, and

FIG. 4 is a schematic representation of a third embodiment of the blocking element according to the invention.

### DETAILED DESCRIPTION OF THE PREFERRED EMBODIMENTS

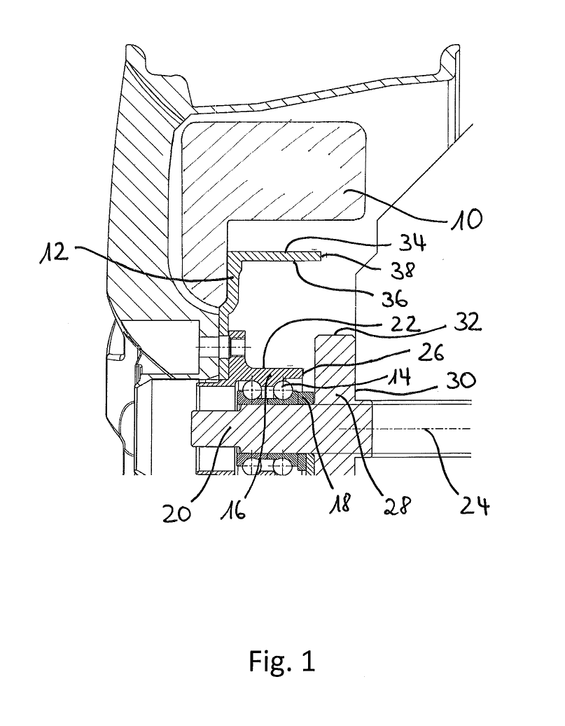

FIG. 1 shows a wheel hub drive unit according to the invention with a wheel hub drive that has a motor unit 10 and a brake drum 12. The wheel hub drive is attached to a wheel hub 20 by a bearing element 14 that has a bearing outer ring 16 and a bearing inner ring 18. The mechanical blocking element according to the invention, not shown here, can be provided, for example, on the lateral surface 22 of the bearing outer ring 16, so that the blocking element can then apply a braking force in the axial direction relative to the rotational axis 24 of the wheel hub 20 on the lateral surface 22 of the bearing outer ring 16. It is further possible to provide the blocking element on the end face 26 of the bearing outer ring 16 so that the blocking element can act in the radial direction relative to the rotational axis 24 of the wheel hub 20 on the end face 26 of the bearing outer ring 16, in order to be able to apply a braking force on the bearing outer ring 16 and thus on the wheel hub 20. The arrangement of the blocking element on the bearing outer ring 16 is then advantageously provided when the bearing outer ring 16 has a rotating design. If the bearing inner ring 18 has a rotating design, then a flange journal 28 can extent past the bearing outer ring 16, so that it is then also possible to provide the blocking element on the lateral surface 30 or the end face 32 of the flange journal 18, so that the blocking element can act in the radial or axial direction relative to the rotational axis 24 of the wheel hub 20 directly on the flange journal 18 and thus indirectly on the wheel hub 20. As an alternative hereto, it is further possible that the blocking element is provided on the brake drum 12, wherein the blocking element is then preferably provided on the outer lateral surface 34, the inner lateral surface 36, or the end face 38 of the brake drum.

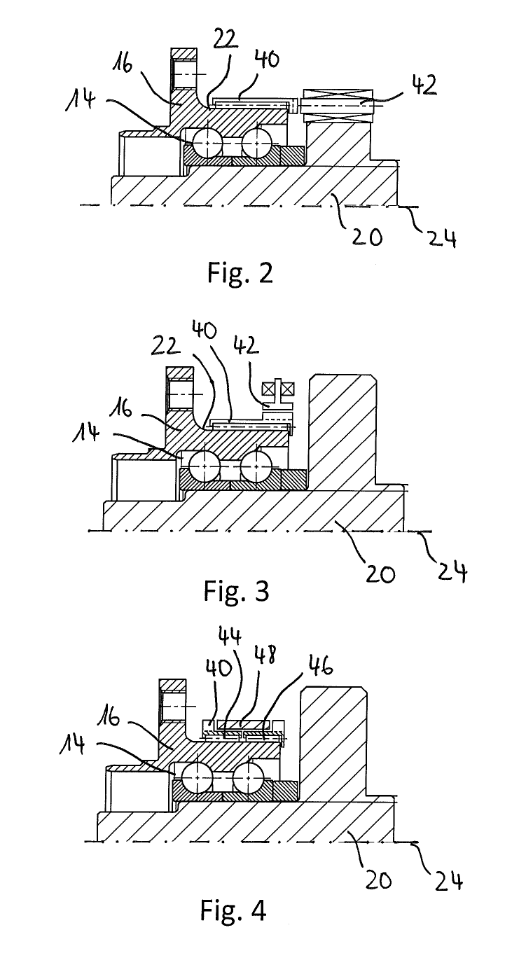

FIG. 2 shows a schematic representation of a first possible embodiment of the blocking element according to the invention in which a blocking element 40 designed as a free wheel is arranged on the lateral surface 22 of the bearing outer ring 16. Here, the free wheel is shown as a sleeve free wheel that can be locked from the wheel carrier side by a block 42 actuated electromagnetically. The braking force is here applied in the axial direction relative to the rotational axis 24 of the wheel hub 20.

FIG. 3 shows another possible embodiment of the blocking element according to the invention in which the blocking element 40 is likewise designed as a free wheel in the form of a sleeve free wheel, wherein here an interlock 42 acts in the radial direction relative to the rotational axis 24 of the wheel hub 20 on the blocking element 40, in order to generate a braking force directly from the lateral surface 22 of the bearing outer ring 16 and thus indirectly on the wheel hub 20. The interlock 42 is here designed with ramps and a spring load such that it can skip in the event of an overload.

FIG. 4 shows schematically a third possible embodiment of the blocking element according to the invention, wherein here the blocking element 40 has two free wheels, a first free wheel 44, and a second free wheel 46 that are provided parallel to each other or one behind the other on the lateral surface 22 of the bearing outer ring 16, wherein the two free wheels 44, 46 can be activated independently of each other by a switchover catch 48. Therefore it is possible to provide a climbing assist feature both for driving up an incline and also for driving down an incline. The braking force is applied directly on the lateral surface 22 of the bearing outer ring 16 and indirectly on the wheel hub 20 in the radial direction relative to the rotational axis 24 of the wheel hub 22.

In a deactivated state, the blocking element 40 is advantageously decoupled such that no friction moments and thus no braking forces are generated on the vehicle wheel. In an activated state, the blocking element 40 advantageously designed as a free wheel runs simultaneously in a free wheel function and blocks the moment when the motor vehicle begins to roll from standstill in the blocking direction. In this blocked state it is possible, through decoupling, to lift the blocking element 40 and thus the blocking effect of the blocking element 40 or the braking force effect of the blocking element 40. This is necessary, for example, in the case when the driver stops on an incline with an active system and decides to drive backwards. Likewise, the case can occur that the motor vehicle is parked on an incline and the climbing assist feature is used as a parking brake and for continued driving would like to initially roll backwards. Here, canceling the blocking function of the blocking element 40 is equal to releasing a parking brake.

This wheel hub drive unit according to the invention with a mechanical blocking element 40 for achieving a braking force effect is used advantageously in electric vehicles.

### LIST OF REFERENCE SYMBOLS

10 Motor unit

12 Brake drum

14 Bearing element

16 Bearing outer ring

18 Bearing inner ring

20 Wheel hub

22 Lateral surface

24 Rotational axis

26 End face

28 Flange journal

30 Lateral surface

32 End face

34 Outer lateral surface

36 Inner lateral surface

38 End face

40 Blocking element

42 Interlock

44 Free wheel

46 Free wheel

48 Switchover catch

1. Wheel hub drive unit for driving a vehicle wheel of a motor vehicle, comprising
a wheel hub drive that has a bearing element by which the wheel hub drive is arranged on a wheel hub of the motor vehicle,
the wheel hub drive has a mechanical blocking element for applying a braking force on the wheel hub.

2. Wheel hub drive unit according to claim 1, wherein for applying the braking force, the blocking element acts in at least one of a radial or an axial direction relative to a rotational axis of the wheel hub on a surface of the bearing element.

3. Wheel hub drive unit according to claim 1, wherein for applying the braking force, the blocking element acts in at least one of a radial or an axial direction relative to a rotational axis of the wheel hub on a surface of a brake drum provided on the wheel hub drive.

4. Wheel hub drive unit according to claim 1, wherein for applying the braking force, the blocking element acts in at least one of a radial or an axial direction relative to a rotational axis of the wheel hub on a surface of a flange journal provided on the wheel hub drive.

5. Wheel hub drive unit according to claim 1, wherein the blocking element is actuatable by at least one of an electric motor, electromagnet, or a mechanical system.

6. Wheel hub drive unit according to claim 1, wherein the blocking element comprises a free wheel.

7. Wheel hub drive unit according to claim 6, wherein a first free wheel and a second free wheel are provided, and the first free wheel and the second free wheel are activatable separately from each other by a switchover catch.

8. An electric motor vehicle, comprising a wheel hub drive unit according to claim 1.
